(19) United States
(12) Patent Application Publication
(10) Pub. No.: US 2020/0099184 A1
(43) Pub. Date: Mar. 26, 2020

(54) LOW-PROFILE AC INLET

(71) Applicant: Apple Inc., Cupertino, CA (US)

(72) Inventors: Sanju Bose, New City, NY (US); Rui Zhou, Sunnyvale, CA (US); Mahmoud R. Amini, Sunnyvale, CA (US); Richard P. Howarth, San Francisco, CA (US)

(73) Assignee: Apple Inc., Cupertino, CA (US)

(21) Appl. No.: 16/428,722

(22) Filed: May 31, 2019

Related U.S. Application Data
(60) Provisional application No. 62/735,343, filed on Sep. 24, 2018.

(51) Int. Cl. H01R 31/06; H01R 24/20; H01R 24/28; H01R 13/6597; H01R 43/26; H01R 13/405; H01R 13/6584

(52) U.S. Cl. CPC H01R 31/06; H01R 24/20; H01R 24/28; H01R 2105/00; H01R 43/26; H01R 13/405; H01R 13/6584; H01R 13/6597

(57) ABSTRACT

AC inlets that have a low profile, are able to withstand side-to-side and axial forces, and are readily manufactured. An example can provide an AC inlet having a low-profile by providing power and ground prongs where the power and ground prongs are attached to flanges that can extend laterally from a back end of each prong. This lateral distribution of power and ground can reduce a depth of the AC inlet and provide the AC inlet with a low profile.

### CROSS-REFERENCES TO RELATED APPLICATIONS

This application claims the benefit of U.S. provisional patent application No. 62/735,343, filed Sep. 24, 2018, which is incorporated by reference.

### BACKGROUND

The number and types of electronic devices available to consumers have increased tremendously the past few years and this increase shows no signs of abating. Devices such as desktops, all-in-one computers, storage devices, monitors, and other devices have become ubiquitous.

These electronic devices can receive power from wall sockets or outlets through power cords. These power cords can have a plug that be inserted into an AC inlet in the electronic device. These AC inlets are often located in a rear surface or rear panel of the electronic device. For example, these power cords can have a plug that is inserted into an AC inlet in a direction that is orthogonal to a rear of the electronic device.

Many of these devices have become slimmer over time. To save space and improve the appearance of these devices, manufactures are continuing to provide even slimmer or thinner devices. But the size, particularly the depth of these AC inlets, can limit a device's thickness. Accordingly, it can be desirable to provide AC inlets having a low-profile.

These power cords can extend from an electronic device to a wall socket or outlet that can be several feet away. Unfortunately, this can leave the power cord exposed where it can be pulled on by people or equipment. For example, someone can trip over the power cord and thereby exert a side-to-side or non-axial force on the AC inlet. Also, users can insert the plug on the power cord into the AC inlet with an excessive force in the axial direction. In extreme cases, these excessive side-to-side and axial forces could damage the electronic device.

These electronic devices can be manufactured and sold in very high volumes. This can necessitate the need for very high volumes of these AC inlets. Accordingly, it can be desirable that these AC inlets be readily manufactured to conserve resources and to ensure that the demand for them can be met.

Thus, what is needed are AC inlets that have a low profile, are able to withstand side-to-side and axial forces, and are readily manufactured.

### SUMMARY

Accordingly, embodiments of the present invention can provide AC inlets that have a low profile, are able to withstand side-to-side and axial forces, and are readily manufactured. An illustrative embodiment of the present invention can provide an AC inlet having a low-profile. This low-profile can be achieved by providing power and ground prongs for a C6 or other AC inlet, where the power and ground prongs are attached to flanges that can extend laterally from a back end of each prong. These flanges can be covered on each side with a thin housing layer, and the result can be shielded with a thin shield This lateral distribution of power and ground, as well as the thin housing and shield layers, can reduce a depth of the AC inlet and provide it with a low profile.

These and other embodiments of the present invention can provide other features that can help to reduce a thickness of an AC inlet. For example, screws or other fasteners can attach a housing of the AC inlet to posts or other structures in a device enclosure housing the AC inlet. The fasteners can pass through holes or openings in the housing. Heads of the screws or fasteners can be seated in recesses of the housing such that they do not add to an overall thickness of the AC inlet. Also, power can be provided from the AC inlet over power conductors. The housing can include a cut-out or notch that can provide a route path for the power conductors. In this way, the power conductors can be positioned such that they do not add to an overall thickness of the AC inlet.

These and other embodiments of the present invention can provide AC inlets that are able to withstand axial forces. The flanges extending laterally from the power and ground prongs can be covered by a plastic housing on a front and rear side. The flanges can include holes or openings to allow the plastic housing on the front side to join with the plastic housing on the rear side. This can provide a “rebar-like” reinforced rear surface for the AC inlet that can be able to withstand axial forces when a plug is inserted by a user.

These and other embodiments of the present invention can provide AC inlets that are able to withstand side-to-side forces. The flanges attached to the power prongs can include sections at a right angle to the portions of flanges that extend laterally from the power prongs. These right-angle sections can be encased in the plastic housing. These right-angle sections can include holes to allow the plastic housing on a first side of the right-angle sections to join with the plastic housing on a second side of the right-angle sections. As before, this can provide a “rebar-like” reinforced sidewall for the AC inlet that can be able to withstand side-to-side forces, for example when a power cord having a plug inserted into the AC inlet is pulled.

These and other embodiments of the present invention can provide an AC inlet that is readily manufactured. The AC inlet can include first and second power prongs and a ground prong. These prongs can be formed by screw machines, computer numerical control (CNC) machines or other lathes or machines. Flanges can be stamped and attached to a rear of the power and ground prongs. The flanges can be attached using soldering, clinching, riveting, or other technique. The flanges can include lateral sections that can extend laterally from the rear of each of the power and ground prongs. One or more right-angle sections can be located at edges of the lateral sections and can be positioned at a right-angle to the lateral sections. These right-angle sections can extend in the same direction and be in parallel to the power and ground prongs. The flanges for the power prongs can include power tabs that can extend substantially in a lateral direction from the lateral sections. These tabs can be connected to power conversion or filtering circuitry. A ground tab can extend at a right angle from the flange of the ground prong and be in an opposite direction as the power and ground prongs.

A housing can be formed around the flanges of the power and ground prongs. This housing can be formed using insert molding or other manufacturing technique. The housing can include a receptacle cavity for accepting a power plug, such as a C6 or other power plug. The power and ground prongs can extend from a rear surface of the receptacle cavity and they can be in parallel with sidewalls of the receptacle cavity. The rear surface of the housing can be formed over each side of the lateral sections of the flanges for the power and ground prongs. The lateral sections can include holes or openings to join the housing on each side of the lateral sections. This can provide a reinforced rear surface for the AC inlet that can be able to withstand axial forces when a plug is inserted by a user.

The sidewalls of the receptacle cavity can be formed over each side of the right-angle sections of the power flanges. The right-angle sections can include holes or openings to join the housing on each side of the right-angle sections. This can provide a reinforced sidewall for the AC inlet that can be able to withstand side-to-side forces when a plug in the AC inlet experiences a sideways force.

These and other embodiments of the present invention can include power supply conversion or filtering circuitry, or both. This circuitry can be located in a shielded housing or filter can. The filter can may house circuitry for power supply conversion or filtering circuitry, or both. This circuitry can connect to the power tabs of the flanges of the power prongs. In order to do this, the power tabs can be temporarily bent in the same direction as the power and ground prongs. If needed, a recess can then be formed in the housing, though this recess can be formed as part of the housing. The filter can may include a notch to accept the ground tab on the flange for the ground prong, and the ground tab can be soldered or otherwise attached to the filter can at the notch. The filter can may be attached to the recess using an adhesive, such as a pressure-sensitive adhesive, heat activated adhesive, temperature-sensitive adhesive, or other adhesive. The power tabs can then be bent back to their original position, which can be orthogonal to the power and ground prongs. Power supply conversion or filtering circuitry, or both, can be placed in the filter can and electrically connected to the power tabs. An internal power cord having an internal power plug can be electrically connected to the power supply conversion or filtering circuitry. A shield can be attached to the housing using an adhesive, such as a pressure-sensitive adhesive, heat activated adhesive, temperature-sensitive adhesive, or other adhesive.

In these and other embodiments of the present invention, prongs, flanges, shields, and other conductive portions of an AC inlet can be formed by stamping, forging, metal-injection molding, deep drawing, machining, micro-machining, screw-machining, 3-D printing, clinching, or other manufacturing process. The conductive portions can be formed of stainless steel, steel, copper, copper-titanium, phosphor-bronze, or other material or combination of materials. They can be plated or coated with nickel, gold, or other material. The nonconductive portions, such as housings and other structures, can be formed using insert molding, injection molding, or other molding, 3-D printing, machining, or other manufacturing process. The nonconductive portions can be formed of silicon or silicone, rubber, hard rubber, plastic, nylon, liquid-crystal polymers (LCPs), ceramics, or other nonconductive material or combination of materials.

Embodiments of the present invention can provide AC inlets that can be located in various types of devices, such as desktop computers, all-in-one computers, storage devices, audio devices and equipment, monitors, power supplies, video delivery systems, and other devices.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system that can be improved by the incorporation of an embodiment of the present invention;

FIG. 2 illustrates a front side of an AC inlet according to an embodiment of the present invention;

FIG. 3 illustrates a backside of an AC inlet according to an embodiment of the present invention;

FIG. 4 illustrates a backside of an AC inlet according to an embodiment of the present invention, where a shield has been removed;

FIG. 5 illustrates an exploded view of a portion of an AC inlet according to an embodiment of the present invention;

FIG. 6 illustrates an exploded view of another portion of an AC inlet according to an embodiment of the present invention; and

FIG. 7 through FIG. 9 illustrates a method of assembling a portion of an AC inlet according to an embodiment of the present invention.

### DESCRIPTION OF ILLUSTRATIVE EMBODIMENTS

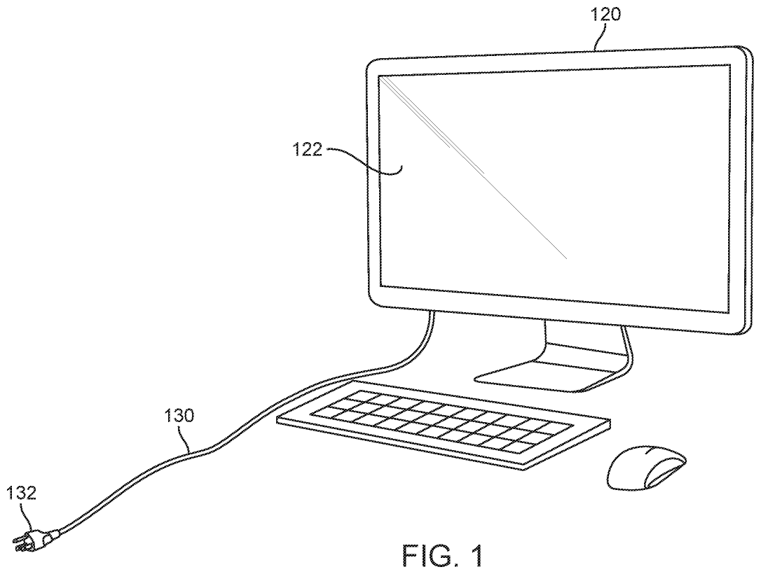

FIG. 1 illustrates an electronic system that can be improved by the incorporation of an embodiment of the present invention. This figure, as with the other included figures, is shown for illustrative purposes and does not limit either the possible embodiments of the present invention or the claims.

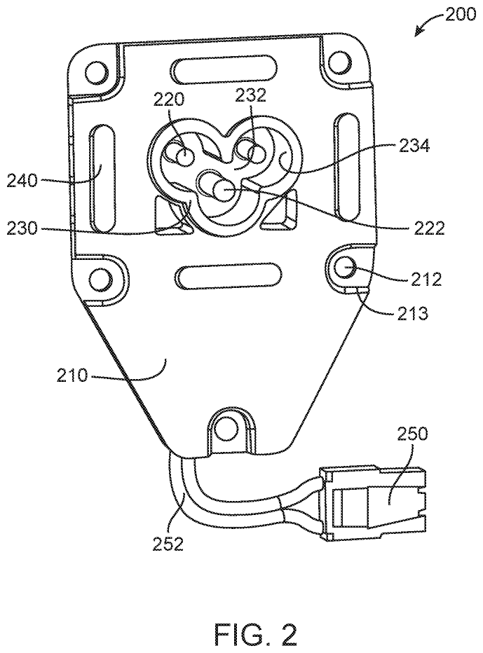

This example illustrates a monitor 120 having a screen 122. Monitor 120 can be powered through power cord 130, which can include a plug 132 at a first end. Plug 132 can be configured to plug into a wall socket or outlet. Power cord 130 can include a second plug at a second end (not shown.) This second plug can be compatible with a standard such as C6 plug consistent with the International Electrotechnical Commission (IEC) 60320 standard, or other plug consistent with another standard. This second plug can be inserted by a user into AC inlet 200 (shown in FIG. 2.) AC inlet 200 can be located on a rear of monitor 120. In these and other embodiments of the present invention, other devices, such as desktop computers, all-in-one computers, storage devices, audio devices and equipment, monitors, power supplies, video delivery systems, and other devices, can be powered using AC inlet 200.

Power cord 130 can be inserted by a user into AC inlet 200 in a rear of monitor 120. On occasion, this insertion can be done with excessive force. In a worst-case situation, this can damage AC inlet 200 and monitor 120. Accordingly, embodiments of the present invention can provide AC inlet 200 having a durable rear surface that can be able to withstand the axial forces involved in inserting a plug on power cord 130. Also, power cord 130 can be tripped over or subject to other forces. Accordingly, embodiments of the present invention can provide AC inlet 200 and having durable sidewalls that can be able to withstand side-to-side forces. An example is shown in the following figures.

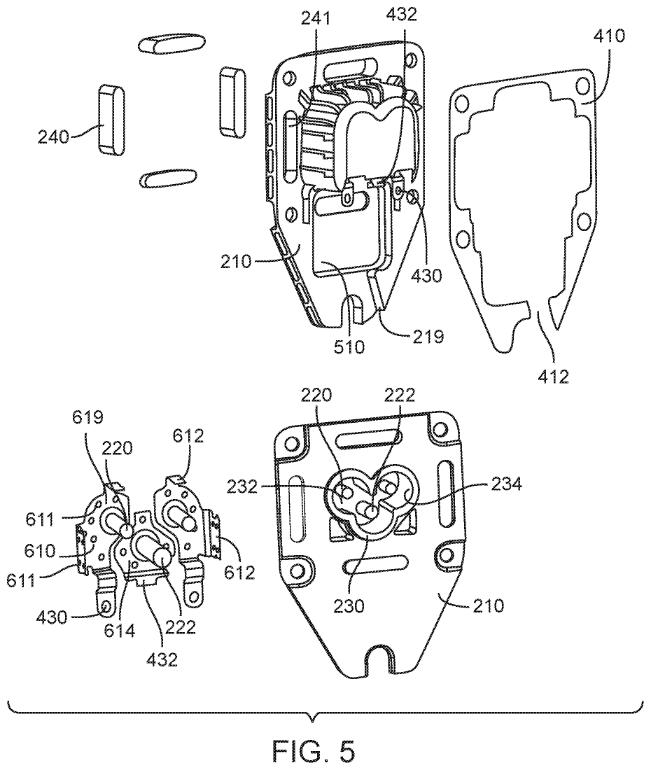

FIG. 2 illustrates a front side of an AC inlet according to an embodiment of the present invention. Power prongs 220 and ground prong 222 can extend from a rear surface 232 of receptacle cavity 230 in housing 210 of AC inlet 200. Receptacle cavity 230 can further include sidewall 234, where sidewall 234 is parallel to and around power prongs 220 and ground prong 222. A plug, for example a C6 plug, can be inserted into receptacle cavity 230 to mate with power prongs 220 and ground prong 222. Housing 210 can further support gaskets 240 in corresponding openings 241 (shown in FIG. 5.) Gaskets 240 can be compressible and can provide an electrical connection between the AC inlet 200 and a device enclosure. Housing 210 can further include openings 212 for fasteners (not shown), such as screws, that can be inserted into standoffs or other features in a device enclosure (not shown.) Openings 212 can be located in recessed portions 213. A head of a screw or other fastener can be located in each recessed portion 213. Locating the head of a screw or other fastener in recessed portion 213 can help to limit an overall thickness of AC inlet 200. AC inlet 200 can provide power over internal plug 250 via conductors 252.

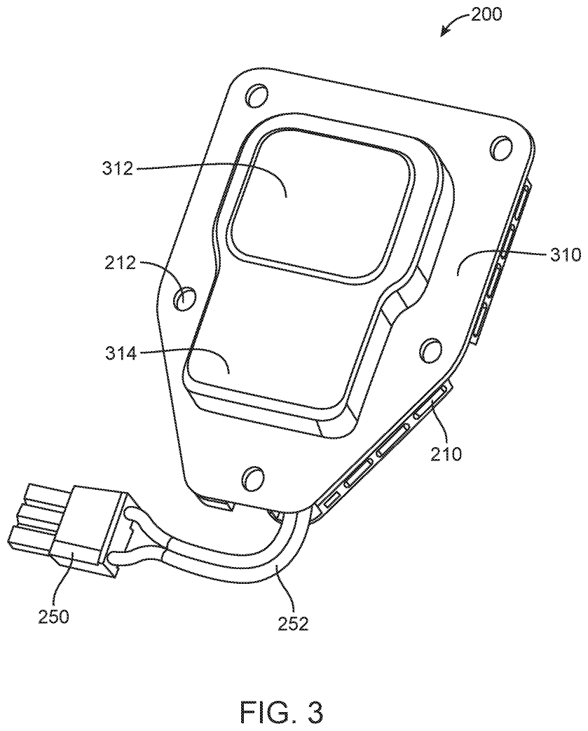

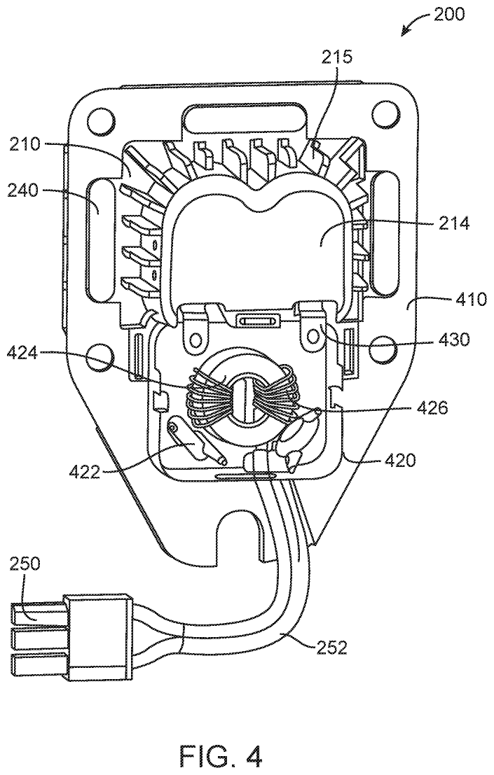

FIG. 3 illustrates a backside of an AC inlet according to an embodiment of the present invention. In this example, shield 310 can be attached to housing 210 of AC inlet 200. Shield 310 can include a first raised portion 314 and a second raised portion 312. Raised portion 314 can be located over filter can 420 (shown in FIG. 4.) Raised portion 312 can be located over a rear of receptacle cavity 230 (shown in FIG. 2.) As before, opening 212 can accept a screw or fastener that can be screwed or otherwise fastened to standoffs or other features in a device enclosure (not shown.) AC inlet 200 can provide power over internal plug 250 via conductors 252.

FIG. 4 illustrates a backside of an AC inlet according to an embodiment of the present invention, where a shield has been removed. In this example, shield 310 (shown in FIG. 3) has been removed from (or not yet attached to) housing 210 of AC inlet 200. Raised portion 214 can be a backside of receptacle cavity 230 (shown in FIG. 2.) Raised portion 214 can include fins 215 for improving a side-to-side strength of receptacle cavity 230. Fins 215 can also be helpful in radiating heat and making a good physical connection to in inside surface of shield 310. Adhesive 410 can be placed over a back side of housing 210 to attach shield 310. Adhesive 410 can be a pressure-sensitive, a heat-activated adhesive, a temperature-sensitive adhesive, or other adhesive. Power tabs 430 can be located over filter can 420. Filter can 420 can include power conversion components, filter components or both. In this example, filter components, such as an inductive choke including core 424 having windings 426, and Y-capacitors 422, can be included in filter can 420. Gaskets 240 can be located in corresponding openings 241 (shown in FIG. 5) in housing 210. AC inlet 200 can provide power over internal plug 250 via conductors 252 to circuitry (not shown) in an electronic device, such as monitor 120 (shown in FIG. 1.)

FIG. 5 illustrates an exploded view of a portion of an AC inlet according to embodiments of the present invention. In this example, housing 210 can include openings 241 for gaskets 240. Gaskets 240 can be formed using foam, fabric over foam, or other compressible or other materials. Gaskets 240 can be conductive or nonconductive. A layer of adhesive 410 can be placed over portions of a back surface of housing 210. Adhesive 410 can be a pressure-sensitive adhesive, heat-activated adhesive, temperature-sensitive adhesive, or other type of adhesive. Housing 210 and adhesive 410 can include cut-outs or notches 219 and 412 for internal power conductors 252 (shown in FIG. 4.) Guiding power conductors 252 through cut-outs or notches 219 and 412 can help to reduce an overall thickness of AC inlet 200.

Power prongs 220 can be attached to flanges 619 that can include lateral sections 610. Lateral sections 610 can extend laterally from a rear of power prong 220. Right-angle sections 612 can be located at edges of lateral sections 610. Right-angle sections 612 can form a right-angle with (or be orthogonal to) lateral sections 610 and can extend in the same direction as, and be parallel to, power prongs 220 and ground prong 222. Lateral sections 610 can also include power tabs 430. Ground prong 222 can attached to a flange that can include lateral section 614 and ground tab 432. These power prongs 220 and ground prong 222 can be formed by screw machines, CNC machines or other lathes or machines. Flanges 619 can be stamped and attached to a rear of power prongs 220 and ground prong 222. Flanges 619 can be attached to power prongs 220 and ground prong 222 using soldering, clinching, riveting, or other technique.

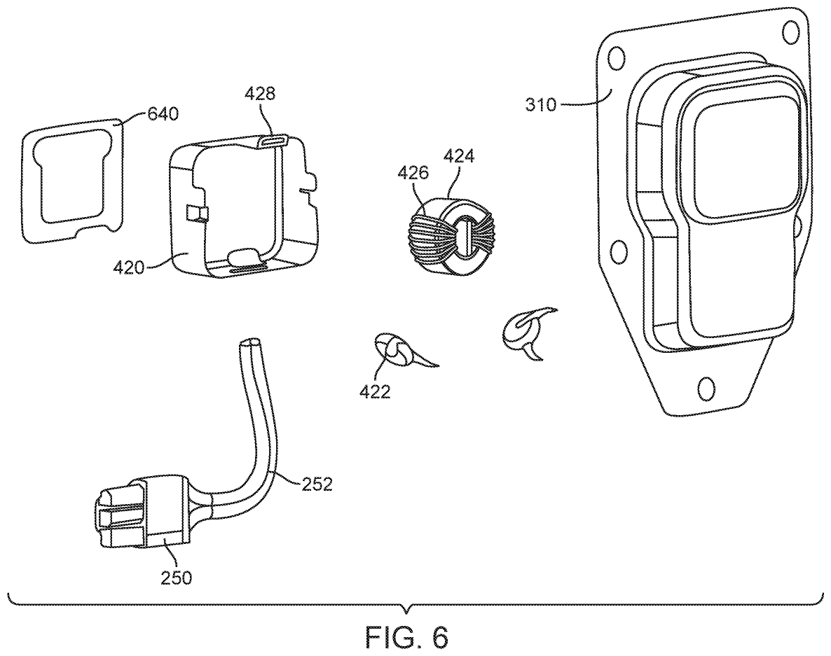

A rear surface 232 of receptacle cavity 230 in housing 210 can be formed around lateral sections 610 and 614. Housing 210 can be formed using insert molding or other manufacturing technique. Specifically, portions of the housing can be formed on each side of lateral sections 610 and 614. These lateral sections can include holes 611. Holes 611 can allow the housing on each side of lateral sections 610 and 614 to be joined. This can provide a reinforced rear surface 232 for receptacle cavity 230. This reinforced rear surface 232 can be strong enough to withstand axial forces applied when a user plugs a corresponding plug (not shown) into receptacle cavity 230. Recess 510 can be formed in housing 210 to support filter can 420 (shown in FIG. 6.)

Similarly, sidewalls 234 can be formed on each side of, or around, right-angle sections 612. Right-angle sections 612 can also have holes 611 such that portions of sidewall 234 on each side of right-angle sections 612 can be joined together. This can form a reinforced sidewall 234 for receptacle cavity 230. Reinforced sidewall 234 can be able to withstand side-to-side forces on receptacle cavity 230 when power cord 130 (shown in FIG. 1) is pulled, tripped over, or otherwise acted upon.

FIG. 6 illustrates an exploded view of another portion of an AC inlet according to an embodiment of the present invention. In this example, filter can 420 can be attached to recess 510 in housing 210 (shown in FIG. 5) with adhesive 640. Filter can 420 can be formed by stamping, using a deep draw process, or other technique. Adhesive 640 can be a pressure-sensitive adhesive, a heat-activated adhesive, temperature-sensitive adhesive, or other adhesive. Adhesive 640 can be die cut or formed in other ways. Filter can 420 can further include slot 428. Slot 428 can accept ground tab 432 (shown in FIG. 5) to ground filter can 420. Filter can 420 can support or hold power supply conversion or filtering circuitry, which in this example can include a common-mode choke formed by core 424 wrapped by windings 426, as well as Y-capacitors 422. Shield 310 can attached to backside of housing 210 using adhesive 410 (shown in FIG. 5.) Shield 310 can be formed by stamping, using a deep draw process, or other technique. Adhesive 410 can be a pressure-sensitive adhesive, a temperature-sensitive adhesive, a heat-activated adhesive, or other adhesive. Adhesive 410 can be die cut or formed in other ways. Power can be distributed to circuits (not shown) inside the electronic device, such as monitor 120, using internal plug 250 and conductors 252. Conductors 252 can be 15 gauge wire, 20 gauge wire, 25 gauge wire, or other wire.

Housing 210, flanges 619, and shield 310 as shown in FIGS. 5 and 6 can provide a thin, durable rear surface 232 for receptacle cavity 230. This thin rear surface 232 can provide an AC inlet 200 having a low profile. In various embodiments of the present invention, the housing 210, flanges 619, and shield 310 can have various thicknesses. For example, lateral sections 610 (and right-angle sections 612) of flanges 619 can have a thickness that is between 0.2 mm and 0.5 mm, between 0.3 and 0.7 mm, or it can have a thickness in a different range. Lateral sections 610 (and right-angle sections 612) of flanges 619 can have a thickness that is 0.25 mm, 0.4 mm, 0.5 mm, 0.6 mm, 0.8 mm, or it can have another thickness. The housing 210 on each side of the lateral sections 610 of flanges 619 can have a thickness that is between 0.2 mm and 0.5 mm, between 0.3 and 0.7 mm, or they can have a thickness in a different range. They can have a thickness that is 0.25 mm, 0.415 mm, 0.510 mm, 0.525 mm, 0.675 mm, 0.85 mm, or they can have another thickness. Shield 310 can have a thickness that is between 0.1 mm and 0.2 mm, between 0.1 and 0.3 mm, between 0.3 and 0.5, or it can have a thickness in a different range. Shield 310 can have a thickness that is 0.1 mm, 0.2 mm, 0.3 mm, 0.4 mm, 0.5 mm, or it can have another thickness.

These and other embodiments of the present invention can provide other features that can help to reduce a thickness of AC inlet 200 (shown in FIG. 2.) For example, screws or other fasteners (not shown) can attach housing 210 (shown in FIG. 5) of AC inlet 200 to posts or other structures in a device enclosure (not shown) housing AC inlet 200. The fasteners can pass through openings 212 (shown in FIG. 2) in housing 210. The heads of the screws or fasteners can be seated in recessed portions 213 (shown in FIG. 2) of housing 210 such that they do not add to an overall thickness of AC inlet 200. Also, power can be provided from AC inlet 200 over power conductors 252 (shown in FIG. 5.) The housing can include cut-out or notch 219 (shown in FIG. 5, which also shows that adhesive 410 can include cutout 412) that can provide a route path for power conductors 252. In this way, power conductors 252 can be positioned such that they do not add to an overall thickness of AC inlet 200.

In these and other embodiments of the present invention, it can be difficult to attach filter can 420 to recess 510 of housing 210 (shown in FIG. 5.) Accordingly, embodiments of the present invention can provide methods for doing so. An example is shown in the following figures.

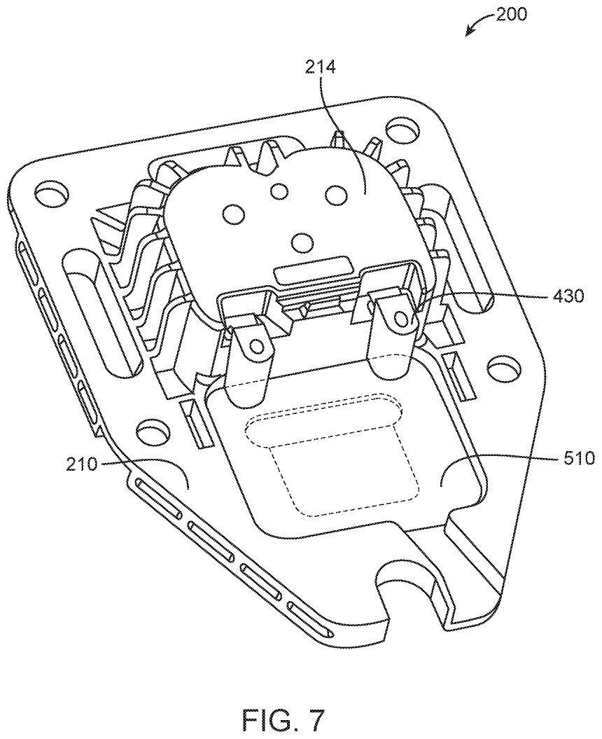

FIG. 7 through FIG. 9 illustrates a method of assembling a portion of an AC inlet according to an embodiment of the present invention. In FIG. 7, a back of AC inlet 200 can include a raised portion 214 supporting power tabs 430. Power tabs 430 can be located over recess 510 in housing 210. Power tabs 430 can be in the way of being able to attach filter can 420 (shown in FIG. 6) into recess 510.

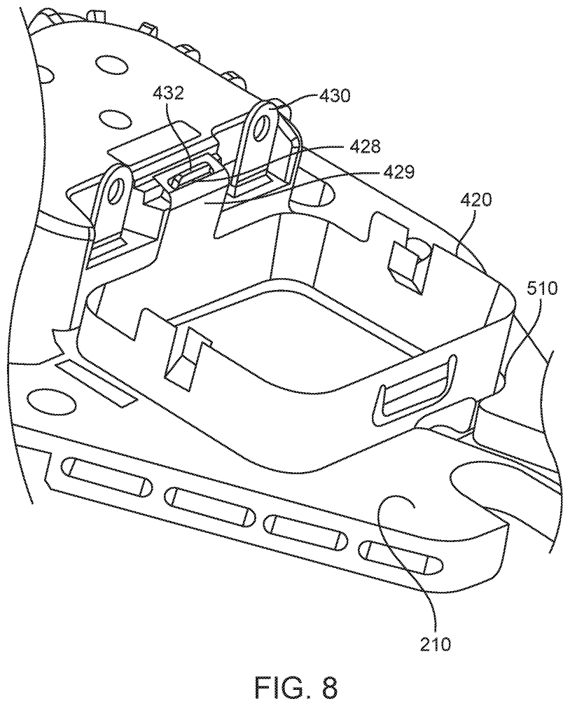

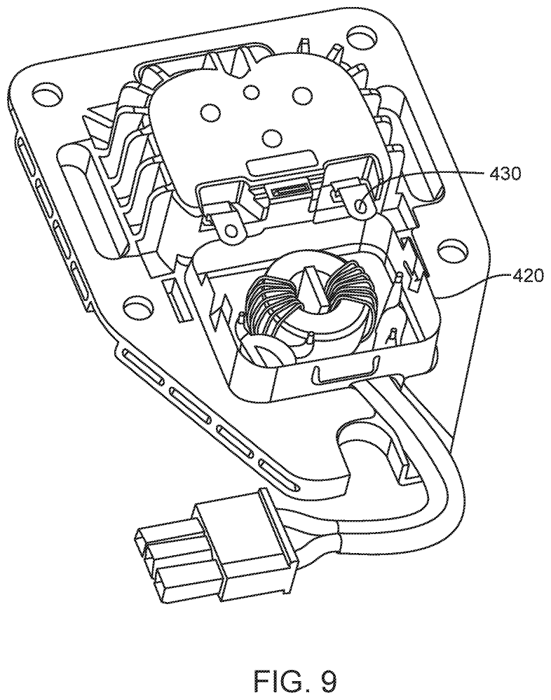

Accordingly, in FIG. 8, power tabs 430 can be bent upright such that they are out of the way of filter can 420. Filter can 420 can be inserted into recess 510 of housing 210. Slot 428 on tab 429 of filter can 420 can fit over ground tab 432 to connect filter can 420 to ground. Once filter can 420 is in place, power tabs 430 can be bent back down over filter can 420 as shown in FIG. 9. At this point, filter components in filter can 420 can be attached to power tabs 430 via conductors (not shown.)

In various embodiments of the present invention, power prongs 220, ground prong 222, shield 310, filter can 420, and other conductive portions of AC inlet 200 shown above can be formed by stamping, forging, metal-injection molding, deep drawing, machining, micro-machining, 3-D printing, or other manufacturing process. These conductive portions can be formed of stainless steel, steel, copper, copper-titanium, phosphor-bronze, or other material or combination of materials. They can be plated or coated with nickel, gold, or other material. The nonconductive portions, such as housing 210 and other structures can be formed using insert molding, injection molding, or other molding, 3-D printing, machining, or other manufacturing process. The nonconductive portions can be formed of silicon or silicone, rubber, hard rubber, plastic, nylon, liquid-crystal polymers (LCPs), ceramics, or other nonconductive material or combination of materials.

Embodiments of the present invention can provide AC inlets 200 that can be located in various types of devices, such as such as desktop computers, all-in-one computers, storage devices, audio devices and equipment, monitors, power supplies, video delivery systems, and other devices.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. An AC inlet comprising:
a first power prong;
a second power prong;
a ground prong;
a first power flange attached to a rear of the first power prong, the first power flange comprising a lateral section extending from the rear of the first power prong, a right-angle section at an edge of the lateral section and at a right angle to the lateral section and parallel to the first power prong, and a power tab extending from the lateral section;
a second power flange attached to a rear of the second power prong, the second power flange comprising a lateral section extending from the rear of the second power prong, a right-angle section at an edge of the lateral section and at a right angle to the lateral section and parallel to the second power prong, and a power tab extending from the lateral section;
a ground flange attached to a rear of the ground prong, the ground flange comprising a lateral section extending from the rear of the ground prong, and a ground tab at a right angle to the lateral section and extending from the lateral section; and
a housing having a receptacle cavity having a rear surface and a sidewall, wherein the rear surface of the housing is formed around the lateral section of the first power flange, the lateral section of the second power flange, and the lateral section of the ground flange, and wherein the sidewall is formed around the right-angle section of the first power flange and the right-angle section of the second power flange.

2. The AC inlet of claim 1 further comprising:
a filter can located in a recess in the housing and connected to the ground tab of the ground flange.

3. The AC inlet of claim 2 wherein the filter can includes a slot and the ground tab fits in the slot.

4. The AC inlet of claim 3 further comprising:
filtering circuitry in the filter can and coupled to the power tab of the first power flange and the power tab of the second power flange.

5. The AC inlet of claim 4 wherein the filtering circuitry comprises a common-mode choke and two Y-capacitors.

6. The AC inlet of claim 1 wherein the lateral section and right-angle sections of the a first power flange, the second power flange, and the ground flange include a plurality of holes.

7. The AC inlet of claim 6 further comprising a shield over a backside of the receptacle cavity.

8. The AC inlet of claim 7 further comprising a plurality of gaskets located in openings in the housing.

9. The AC inlet of claim 8 wherein the housing is insert molded.

10. The AC inlet of claim 1 wherein the first power flange is clinched to first power prong.

11. A method of manufacturing an AC inlet, the method comprising:
forming a first power prong and a first power flange, the first power flange comprising a lateral section extending from the rear of the first power prong, a right-angle section at an edge of the lateral section and at a right angle to the lateral section and parallel to the first power prong, and a power tab extending from the lateral section;
forming a second power prong and a second power flange, the second power flange comprising a lateral section extending from the rear of the second power prong, a right-angle section at an edge of the lateral section and at a right angle to the lateral section and parallel to the second power prong, and a power tab extending from the lateral section;
forming a ground prong and a ground flange, the ground flange comprising a lateral section extending from the rear of the ground prong, and a ground tab at a right angle to the lateral section and extending from the lateral section; and
forming a housing having a receptacle cavity, the receptacle cavity having a rear surface and a sidewall, wherein the rear surface of the housing is formed around the lateral section of the first power flange, the lateral section of the second power flange, and the lateral section of the ground flange, and wherein the sidewall is formed around the right-angle section of the first power flange and the right-angle section of the second power flange.

12. The method of claim 11 wherein the first power prong and the first power flange are formed as a single piece.

13. The method of claim 11 wherein the first power prong and the first power flange are formed separately, the method further comprising attaching the first power flange to a rear of the first power prong.

14. The method of claim 13 wherein the first power flange, the second power flange, and ground flange each comprise a plurality of holes.

15. The method of claim 14 wherein the first power flange is attached to the first power prong by clinching.

16. The method of claim 11 further comprising:
bending the power tab of the first power flange and the power tab of the second power flange such that they extend in the same direction as the first power prong;
forming a recess in the housing;
attaching a filter can in the recess of the housing; and
bending the power tab of the first power flange and the power tab of the second power flange such that they extend in a direction orthogonal to the first power prong.

17. The method of claim 16 wherein the filter can is attached to the housing using a pressure-sensitive adhesive.

18. The method of claim 17 further comprising placing filtering components in the filter and coupling them to the power tab of the first power flange and the power tab of the second power flange.

19. The method of claim 18 further comprising inserting the ground tab in a slot in the filter can and connecting the ground tab to the filter can by soldering.

20. The method of claim 19 further comprising inserting a plurality of gaskets in openings in the housing.
